(19) United States
(12) Patent Application Publication
(10) Pub. No.: US 2016/0232476 A1
(43) Pub. Date: Aug. 11, 2016

(54) WORK STATE MEASUREMENT DEVICE AND WORK STATE MEASUREMENT METHOD

(71) Applicant: MITSUBISHI ELECTRIC CORPORATION, Tokyo (JP)

(72) Inventors: Tomohito NAKATA, Tokyo (JP); Koko HANADA, Tokyo (JP); Yusuke SUGAHARA, Tokyo (JP); Tsubasa TOMODA, Tokyo (JP); Tetsuya TAMAKI, Tokyo (JP); Naoki UEDA, Tokyo (JP)

(73) Assignee: Mitsubishi Electric Corporation, Chiyoda-ku, Tokyo (JP)

(21) Appl. No.: 15/022,847

(22) PCT Filed: Nov. 11, 2014
(86) PCT No.: PCT/JP2014/079803

§ 371 Date: Mar. 17, 2016

(30) Foreign Application Priority Data
Nov. 22, 2013 (JP) 2013-241527

(51) Int. Cl. G06Q 10/06; H04R 29/00

(52) U.S. Cl. CPC G06Q 10/063114; H04R 29/004

(57) ABSTRACT

A work state measurement device comprises an observation timing notifying unit which notifies observation starting timing and observation finishing timing as observation timing to an observer in every preliminarily set time interval, an observation state input unit in which the work state which is observed is divided into a plurality of work state items and an observation state record unit which weights work state items which are inputted in the observation input unit while from observation starting timing to observation finishing timing by information of the work state items which are inputted and records the work state items as observation states.

### TECHNICAL FIELD

This invention relates to a work state measurement device which records observation results of work state of workers who work at factories, shops, construction sites, etc., a work state measurement method and a work state measurement program.

### BACKGROUND ART

As a means of grasping work states of workers and operation states of facilities, a method so-called work sampling method (instantaneous observation method) in which a point of view of statistical sampling inspection is applied is well known. For example, in Non-Patent document 1, the details of a principle and a procedure of work sampling method are disclosed. Work sampling method is technique in which at the observation time which is set in advance, the state of an object to be observed is recorded instantaneously, a rate of appearing of each of the observed state (hereinafter will be referred to as observation state) through a period of time is estimated statistically. Specifically, when observation is performed 100 times periodically in a facility where a state is changed repeatedly from operation state to non-operation state or from non-operation state to operation state, a case in which the number of operation state is 70 incidents and the number of non-operation state is 30 incidents, it is estimated such that the appearance probability of operation state in a facility to be observed, that is, the rate of operation of facility is 70% (=operation observation 70 incidents÷all observations 100 incidents) In the above-mentioned work sampling method, it is only necessary to observe an object to be observed instantaneously, therefore, labor which is required for observation is less. Consequently, the work sampling method has economical advantage, that is, a plurality of objects to be observed can be observed only by one observer.

Further, in Patent Document 1, technology in which observation according to work sampling method is performed by using portable electronic equipment is disclosed, and benefit of using portable electronic equipment, that is, bringing portable electronic equipment in work shop does not disturb moving of workers is disclosed.

### PRIOR ART REFERENCE

### Patent Document

[Patent Document 1]

Japanese Patent Application Laid-Open No. 2004-13886

### Non-Patent Document

[Non-Patent Document 1]

Kazuo Ishikawa and Masakazu Tamai, “Work Sampling” published by Nikkan Kogyo Shinbun, August, 1969

### DISCLOSURE OF THE INVENTION

### Problems to be Solved by the Invention

As above mentioned, according to the work sampling method, the state of an object to be observed is observed instantaneously and is recorded. However, in a case where an object to be observed is a person who works at a factor, a shop, a construction site, etc., that is, a human being, a process of changing from a work state A to another work state B (hereinafter will be referred to as a state change process) is more various in comparison with a case where an object to be observed is a facility. In many cases, processes of changing work state are various, for example, there is a case in which a person who is walking stops and immediately starts to talk on his/her cellular phone, on the other hand, there is another case in which a person who is walking starts to talk on his/her cellular phone before the person stops walking.

According to conventional work sampling methods, in order to sample only the instantaneous state at an observation time point, in a case where a time point which is accidentally observed is in a state change process, whether a work state to be sampled is state before change or state after change is grasped by instantaneously judging. However, in many cases, regarding an object to be observed such as a worker who has various state change processes, it is even for skilled persons to be difficult to observe work sampling instantaneously. For example, in a case where a person who is walking stops and immediately starts to speak on his/her cellular phone, regarding sampling, there may be two incidents, that it, the state is sampled as “walking state” or “talking on his/her cellular phone state”. That is, when the same state change process is observed, observing the state by different observer, or observing the state by the same observer at different observation date and time may generate various sample records. The above-mentioned may become a factor to destabilize the quality of work analysis. Conventionally, there is work state measurement device which records the work state of a plurality of persons to be observed, however, there is no work state measurement device which records a plurality of work states of one person to be observed in a case where the work state of the person is changed.

In order to solve the above-mentioned problems, this invention is made. This invention aims to obtain work state measurement device by which variation of observation results is suppressed so as to stabilize the quality of analyzing work states even in a case where observers in work sampling method are unskilled persons.

### Means for Solving the Problems

According to this invention, work state measurement device, which records a result of observing a work state of a worker which is an object to be observed as an observation state, comprises an observation timing notifying unit which notifies observation starting timing and observation finishing timing as observation timing to an observer in every preliminarily set time interval, an observation state input unit which divides an observed work state into a plurality of work state items and inputs the work state items, and an observation state record unit which weights the work state items, which are inputted while from the observation starting timing to the observation finishing timing, by information of a work state item which is inputted, and records the work state items as observation states.

Further, a work state measurement method, which records an observation result of observing a work state of a worker which is an object to be observed by a calculator, comprises an observation timing notifying step which notifies observation starting timing and observation finishing timing as observation timing to an observer in every preliminarily set time interval, an observation state input step which divides an observed work state into a plurality of work state items and inputs the work state items and an observation state record step which weights the work state items, which are inputted while from observation starting timing to observation finishing timing, by information of the work state items which are inputted, and records the work state items as an observation states.

A work state measurement program, which makes a computer to execute a step which records an observation result of observing a work state of a worker which is an object to be observed, makes the computer to execute an observation timing notifying step which notifies observation starting timing and observation finishing timing as observation timing to an observer in every preliminarily set time interval, an observation state input step which divides an observed work state into a plurality of work state items and inputs the work state items and an observation state record step which weights a work state item, which is inputted while from observation starting timing to observation finishing timing, by information of the work state items which are inputted, and records the work state item as an observation state.

### Advantage of the Invention

This invention can provide work state measurement device by which variation of observation results can be suppressed and the quality of assorting the work state can be stabilized even in a case where a worker is unskilled person.

### BRIEF DESCRIPTION OF THE DRAWINGS

FIG. 1 is a block diagram showing the configuration of work state measurement device according to EMBODIMENT 1 of this invention.

FIG. 2 is an outside drawing of one example of work state measurement device according to EMBODIMENT 1 of this invention which is realized by a portable terminal device.

FIG. 3 is a drawing for describing a basic idea of work analysis.

FIG. 4 is a first diagram for describing a work state measurement method according to general work sampling methods.

FIG. 5 is a second diagram for describing a work state measurement method according to general work sampling methods.

FIG. 6 is a first diagram for describing a work state measurement method by a work analysis equipment according to this invention.

FIG. 7 is a second diagram for describing a work state measurement method by work analysis equipment according to this invention.

FIG. 8 is a block diagram showing one example of the configuration of an observation timing notifying unit of work state measurement device according to EMBODIMENT 1 of this invention.

FIG. 9 is a diagram for showing an example of patrol interval data of a work state measurement device according to EMBODIMENT 1 of this invention.

FIG. 10 is a diagram for showing an example of observation time data of a work state measurement device according to EMBODIMENT 1 of this invention.

FIG. 11 is a flow chart showing an operation of a work state measurement device according to EMBODIMENT 1 of this invention.

FIG. 12 is a diagram for showing an example of a configuration of an input information display unit of a work state measurement device according to EMBODIMENT 1 of this invention.

FIG. 13 is a diagram for showing an example of data which is recorded in an observation state recording unit of a work state measurement device according to EMBODIMENT 1 of this invention.

FIG. 14 is a diagram for showing another example of data which is recorded in an observation state recording unit of a work state measurement device according to EMBODIMENT 1 of this invention.

FIG. 15 is a diagram for showing an example of a configuration of an input information display unit of a work state measurement device according to EMBODIMENT 2 of this invention.

FIG. 16 is a first diagram showing an operation of a work state measurement device according to EMBODIMENT 2 of this invention.

FIG. 17 is a second diagram showing an operation of a work state measurement device according to EMBODIMENT 2 of this invention.

FIG. 18 is a third diagram showing an operation of a work state measurement device according to EMBODIMENT 2 of this invention.

FIG. 19 is a fourth diagram showing an operation of a work state measurement device according to EMBODIMENT 2 of this invention.

FIG. 20 is a fifth diagram showing an operation of a work state measurement device according to EMBODIMENT 2 of this invention.

FIG. 21 is flow chart showing an operation of a work state measurement device according to EMBODIMENT 2 of this invention.

FIG. 22 is a diagram for showing an example of observation result of a work state measurement device according to EMBODIMENT 2 of this invention.

FIG. 23 is a block diagram showing one example of a configuration of an observation timing notifying unit of a work state measurement device according to EMBODIMENT 3 of this invention.

FIG. 24 is a block diagram showing one example of a configuration of an observation state input unit of a work state measurement device according to EMBODIMENT 4 of this invention.

FIG. 25 is a block diagram showing one example of a configuration of an observation state input unit of a work state measurement device according to Embodiment 5 of this invention.

FIG. 26 is a block diagram showing one example of a configuration of an observation state input unit of a work state measurement device according to Embodiment 6 of this invention.

### EMBODIMENT FOR CARRYING OUT THE INVENTION

Before describing embodiments for carrying out this invention, the influence in a case where an observer observes a state change process which is the premise of problems of this invention will be described. Hereinafter, in order to make the description simple, a case having only two kinds of states regarding one facility to be observed, that is, “operation state” and “non-operation state” will be described.

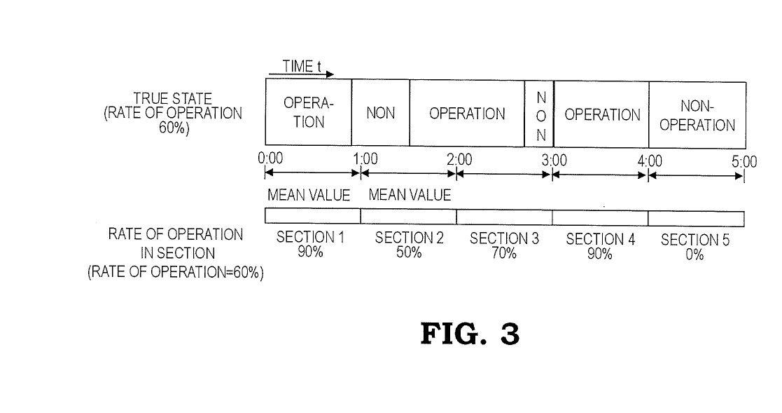

A rate of operation of an object to be observed in a case where the operation state and the non-operation state are repeated alternately agrees with the mean value of the rate of operation in each section (section 1, section 2, . . . , section L) which is obtained by dividing the analysis period into L pieces. For example, as shown in FIG. 3, the rate of operation of whole of observation period in a case where the average time of operation 60 minutes (this does not mean such that one operation duration time of every time is exactly 60 minutes but that the average time of operation duration time of several times is 60 minutes) and the average time of operation: 40 minutes (this does not mean such that one operation duration time of every time is exactly 40 minutes but that the average time of operation duration time of several times is 40 minutes) is repeated alternately agrees with the average value of the rate of operation of each section in a case where the analysis period is divided into 5 sections (L=5), that is,

(the rate of operation in section 1+the rate of operation in section 2+the rate of operation in section 3+the rate of operation in section 4+the rate of operation in section 5)÷5=(90%+50%+70%+90%+0%)÷5=60%

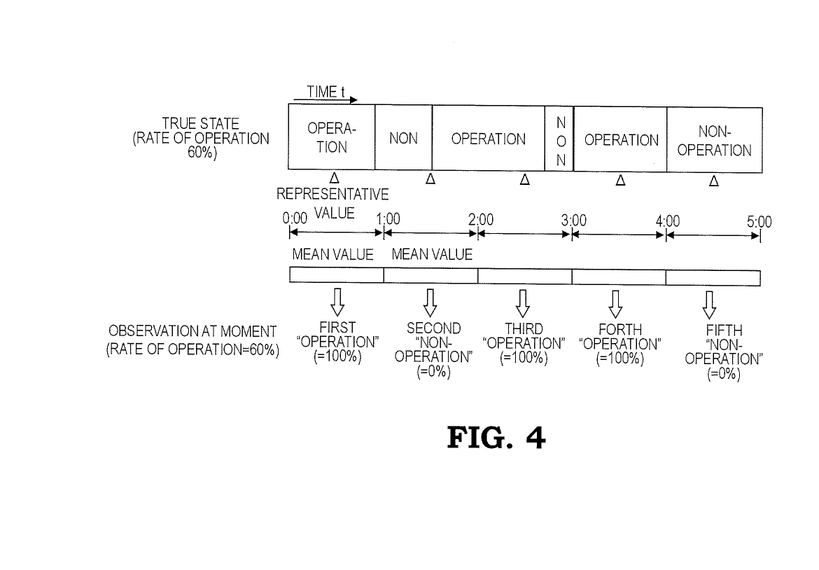

On the other hand, according to work sampling methods, an event which is observed at a certain moment is adopted as a sample as the only representative value in each of the section, therefore, only an extreme value, that is, “operation (100%)” or “non-operation (0%)” is adopted. For example, in FIG. 4, at an instantaneous point of time indicated by A in Figure, the state of each section is observed. At the first observation, time 0:00 to time 1:00, it is observed such that the state is “operation” (that is, the rate of operation is 100%), in the following, at the second observation, it is observed such that the state is “non-operation”(0%), at the third observation, it is observed such that the state is “operation” (100%), at the fourth observation, it is observed such that the state is “operation” (100%) and at the fifth observation, it is observed such that the state is “non-operation” (0%). The rate of operation of whole of analysis period is

(the rate of operation at the first observation+the rate of operation at the second observation+the rate of operation at the third observation+the rate of operation at the fourth observation+the rate of operation at the fifth observation)÷5=(100%+0%+100%+100%+0%)÷5=60%.

Further, the operation state of three incidents out of all incidents of five incidents is observed, therefore, the above-mentioned agrees with the rate which is calculated, that is,

3÷5=0.6(=60%)

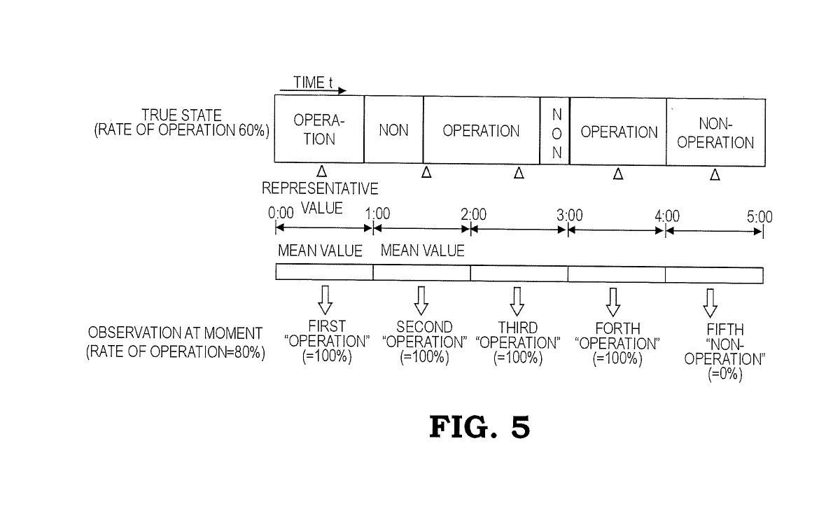

Further, in FIG. 4, an observation point of time in a period of time, time 1:00 to tie 2:00, is the moment which is changed from “non-operation” state to “operation” state, therefore a sample of “operation (the rate of operation is 100%) may be adopted based on an observer's opinion. In FIG. 5, a case in which an observation in a period of time, time 1:00 to time 2:00 is “operation” (the rate of operation is 100%) is adopted as a sample is shown. In this case, the rate of operation of whole of analysis period is

(the rate of operation at the first observation+the rate of operation at the second observation+the rate of operation at the third observation+the rate of operation at the fourth observation+the rate of operation at the fifth observation)÷5=(100%+100%+100%+100%+0%)÷5=80%

As above mentioned, even when there is a slight time lag in observing, the work states may be observed as completely opposite, that is “operation state”, therefore, variation of observation result may be greatly affected.

Specifically, regarding the variation of data of observation sample, in an example in FIG. 3,

{(90%−60%)²+(50%−60%)²+(70%−60%)²+(90%−60%)²+(0%−60%)²÷5=0.112

On the other hand, in an example in FIG. 4,

{(100%−60%)²+(0%−60%)²+(100%−60%)²+(100%−60%)²+(0%−60%)²÷5=0.24

That is, the variation of data of observation according to the work sampling method is greater. As can be seen from the above-mentioned, according to the work sampling method, when the observed state is sampled, the observed state is recorded as the extreme state, that is, 0% or 100%. Consequently, when the state change process is observed, there is the tendency such that the variation of result may be greater.

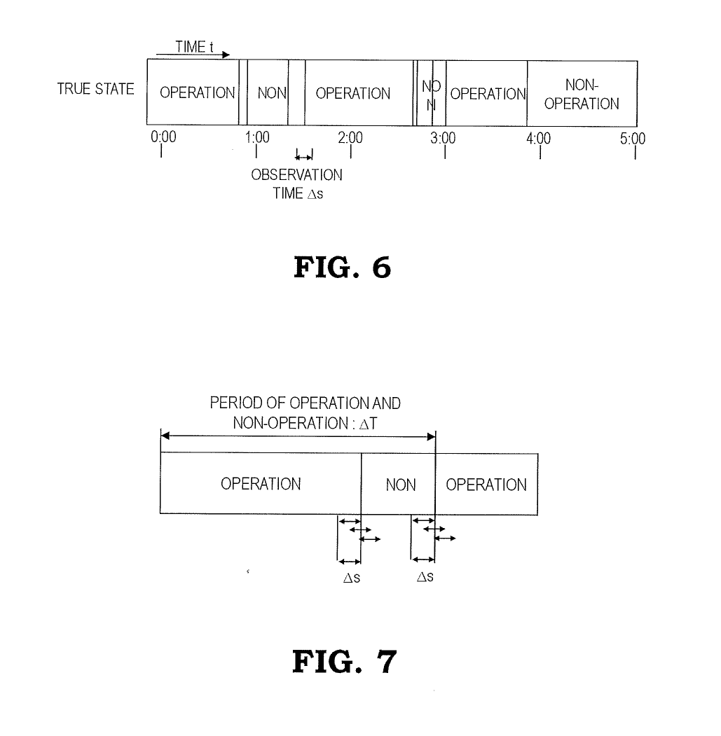

Next, technology concerning this invention will be described. This invention has the characteristic such that observation is performed not at a moment but at a point having the duration of several seconds (As). Hereinafter, referring to FIG. 6 and FIG. 7, the characteristic of observation method according to this invention will be described.

FIG. 6 shows a case in which the state change process is observed, that is, at an observation starting point, the state is non-operation state, therefore a case in which the state is changed from the non-operation state to the operation state during observation time Δs. As above mentioned, in a case where the state is changed during observation, according to this invention, it is sampled such that the state before change (that is, non-operation state) is 0.5 incident, and the state after change (that is, operation state) is 0.5 incident. The above-mentioned event occurs at two points, that is, a point of “operation state to non-operation state” and a point of “non-operation state to operation state”. Therefore, as shown in FIG. 7, the event occurrence probability b in the state change process can be shown as b=2Δs/ΔT, by using the ratio of ΔT: a series of operation—non-operation period starting from operation starting to sequent operation starting via non-operation state and Δs: observation time. Further, when the state of an object to be observed is not changed during observation time, in the same way as that of regular observation method, the state to be observed is sampled as one incident.

In a case where the state of an object to be observed of average rate of operation p is sampled as either a “non-operation (0%)” or an “operation (100%)”, variation of observation data σ² is

σ²=(100%−p)²×p+(0%−p)²×(1−p)=(1−p)×p

On the other hand, in a case where technology concerning this invention is used, in addition to “non-operation (0%)” and “operation (100%)”, data in which state comprises 50% of operation and 50% of non-operation is sampled, variation σc² is

$$\begin{matrix}σ {c}^{2} = {( 100 \% - p )}^{2} \times ( p - b / 2 ) + {( 0 \% - p )}^{2} \times \\ ( 1 - p - b / 2 ) + {( 50 \% - p )}^{2} \times b / 2 \times 2 \\ = {σ}^{2} - b\end{matrix}$$

As above mentioned, by sampling an object to be observed at an observation time having a short duration time, variation can be suppressed small by the event occurrence probability b of a state change process in comparison with a case in which the state of an object to be observed is sampled at a moment.

As above mentioned, by observing an object not at a moment but by providing a short duration observation time, variation of observation result can be improved.

Hereinafter, regarding work state measurement equipment and work state measurement method for carrying out this invention referring to Figures, EMBODIMENTs 1 to 6 will be described. Work state measurement equipment according to this invention comprises the mechanism in which an observation time having a duration time of several seconds is provided in advance and the finishing timing is notified and the mechanism in which a plurality of observation states are recorded in a case where the state of a person to be observed is changed during observation. Therefore, in a case where an event is changed at the same time of observation, the hesitation of observer who is inexperienced to work sampling method, that is, the observer might hesitate such that which state should be recorded, can be reduced.

### Embodiment 1

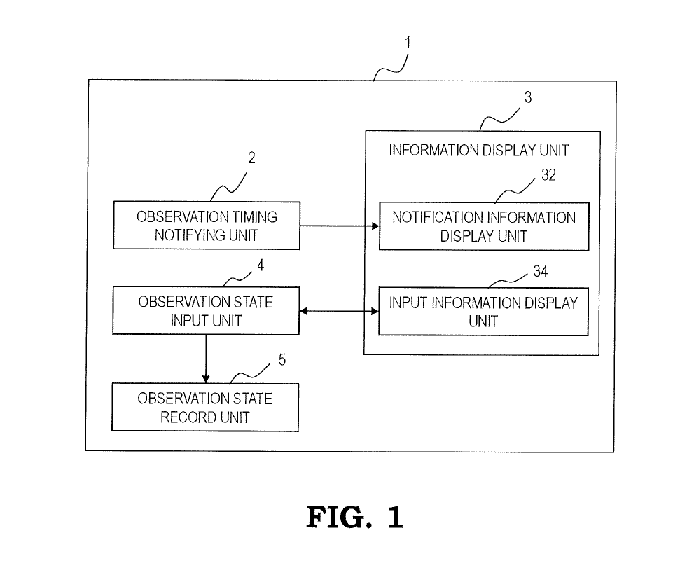

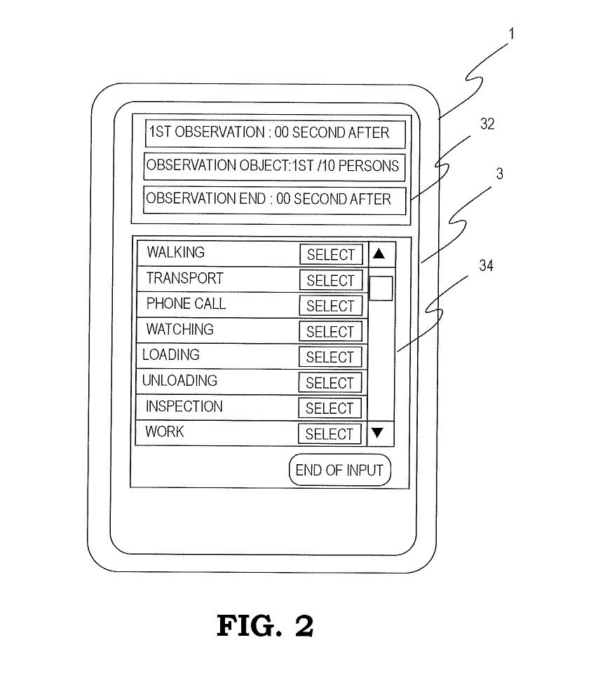

FIG. 1 is a block diagram showing the configuration of work state measurement device 1 and FIG. 2 is an outside drawing of one example of work state measurement device which is realized by a portable terminal unit. The work state measurement device 1 according to EMBODIMENT 1 comprises an observation timing notifying unit 2 which notifies observation starting timing and observation finishing timing, after an observation time which is determined in advance and starts from an observation starting time is elapsed, to an observer, an information display unit 3 which displays various kinds of information including notification information, a work state item, etc., an observation state input unit 4 in a case where a plurality of states of an object to be observed are changed during observation, and an observation state record unit 5 which records the observation state. Regarding work state measurement device of this invention, not only work state measurement device according to EMBODIMENT 1 but also work state measurement device according to all of EMBODIMENTS is realized by a calculator such as portable terminal equipment as shown in FIG. 2 and a personal computer. Further, operation of each unit is executed according to a program, which can be executed by a calculator and is stored in main memory etc., which is not shown in FIG. 2, of work state measurement device which is a calculator.

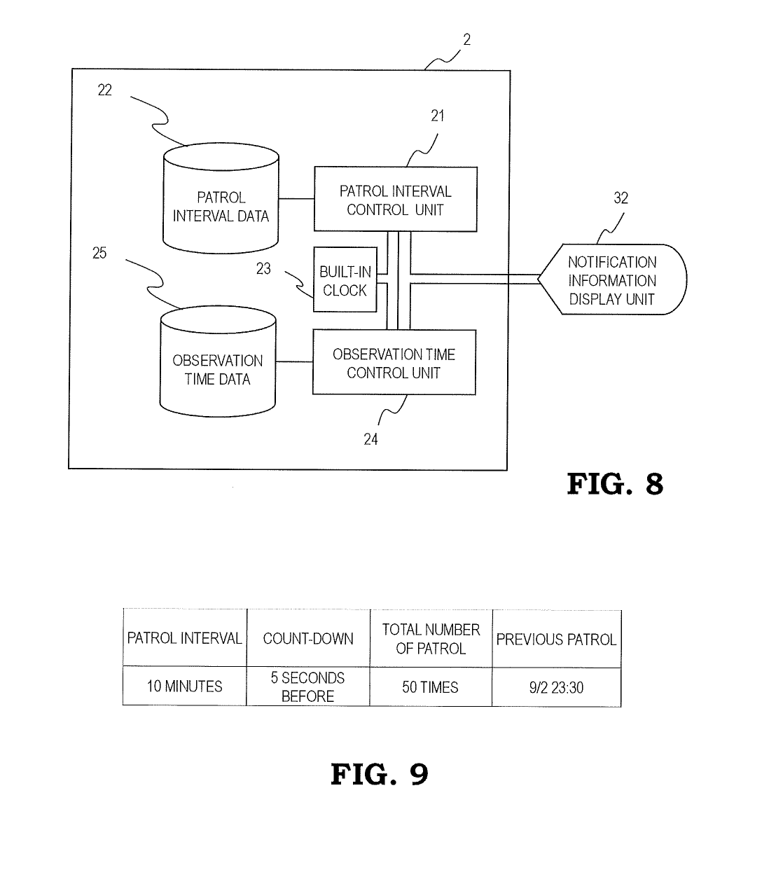

FIG. 8 is a block diagram showing one example of the configuration of the observation timing notifying unit 2 of work state measurement device according to EMBODIMENT 1 of this invention. According to general work sampling methods, an analysis period in which work analysis is performed is divided into several occasions, and patrol observation is performed a plurality of times, a plurality of objects to be observed are observed in one patrol, and work analysis is performed by using observation results. Then, a patrol interval control unit 21 notifies next patrol starting timing to a notification information display unit 32 in the information display unit 3 based on information which is stored in patrol interval data 22 and a built-in clock 23 so as to display the next patrol starting timing. FIG. 9 shows an example of patrol interval data, and the data stores “patrol interval” which designate a notification interval of patrol starting timing, “count-down” which designates how many seconds before to start notifying the remaining time before patrol starting timing as notification of observation starting timing, “the total number of patrol” which designates how many times of patrol is performed during observation period and “previous patrol” which is the notification time of previous patrol starting timing. According to an example of FIG. 9, “patrol interval=10 minutes”, “count-down=5 seconds before”, and “previous patrol=September 2th, 23:30”. With regard to the previous patrol time=September 2nd, 23:30, in order to start next patrol at September 2nd, 23:40, which is after elapse of 10 minutes of patrol interval, count-down is performed 5 seconds before. That is, from September 2nd 23:39:55, for 5 seconds, the notification information display unit 32 is notified. According to the above-mentioned example, patrol starting timing can be exactly notified to an observer.

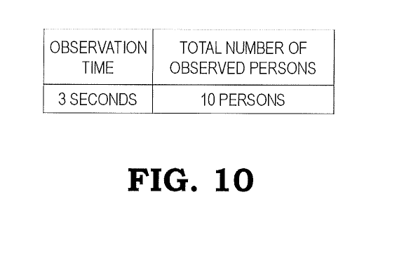

Further, an observation time control unit 24 shown in FIG. 8 displays observation finishing timing in the notification information display unit 32 based on information which is stored in observation time data 25 and the built-in clock 23. According to general work sampling methods, a plurality of states of objects to be observed are observed instantaneously in one patrol, therefore, observation finishing timing does not exist. However, according to this invention, observation is performed by providing observation time having a length of several seconds, therefore observation finishing timing exists. FIG. 10 shows an example of observation time data, and the data stores “observation time” which is time for observing an object to be observed, “total number of observed persons” which is the number of all persons to be observed, etc. According to an example of FIG. 10, “observation time=3 seconds”, with regard to observation starting time, observation finishing timing is notified to the notification information display unit 32 so as to perform observing after an elapse of 3 seconds which is observation time. According to the above-mentioned example, patrol starting timing can be exactly notified to an observer.

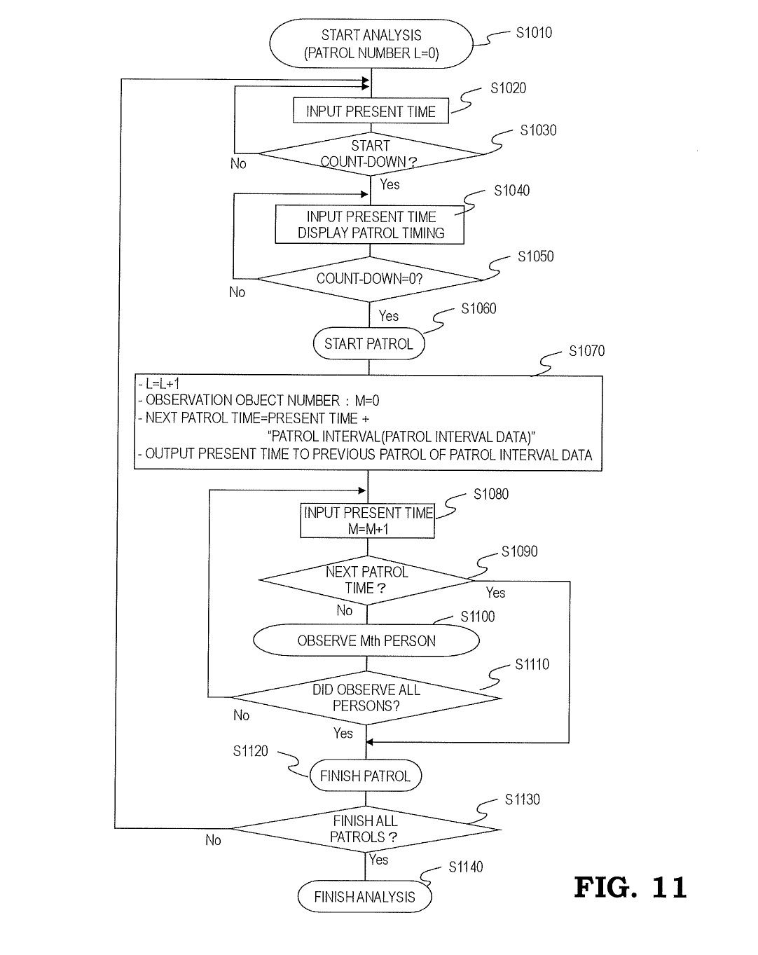

The above-mentioned series of operation flow chart is shown in FIG. 11. In analysis starting step (S1010), the number of patrol L is initialized (=0), in step S1020, present time is obtained by a built-in clock. Determination step S1030 is repeated until the present time gets to count-down starting time of patrol starting. When the present time gets to the count-down starting time (=Yes), the preset time is obtained by a built-in clock, and count-down by the patrol starting time is displayed in a display unit (S1040). Next, determination step S1050 repeats the S1040 and the S1050 until count-down=0. When count-down=0 (=Yes), patrol routine is started to perform in step S1060.

In patrol routine, in step S1070, (1) L is set to be L+1, (2) the number of persons to be observed M is set to be 0, (3) next patrol time is set to be present time+“patrol interval (which is obtained by patrol interval data”, (4) the present time is outputted to “previous patrol” of the patrol interval data, and in step S1080, the present time is obtained by a built-in clock and M is set to be M+1. In determination step S1090, when the preset time gets to next patrol time (=Yes), the patrol of this time is finished, when the preset time does not get to next patrol time (=No), the Mth person to be observed is observed (S1100). The following step S1110 is performed without waiting the observation finishing of the Mth person to be observed (asynchronously), until “all number of persons to be observed” which are determined by observation time data in advance are observed, S1080, S1090 and S1100 are repeated. When all persons to be observed are observed (S1110 Yes), in S1120, patrol routine is finished to perform. In determination step 1130, the above-mentioned steps after S1020 are repeated until the number reaches “the total number of patrol times” which is determined by patrol interval data in advance (S1130 No), at a point when the number reaches “the total number of patrol times” (S1130 Yes), analysis is finished to perform (S1140).

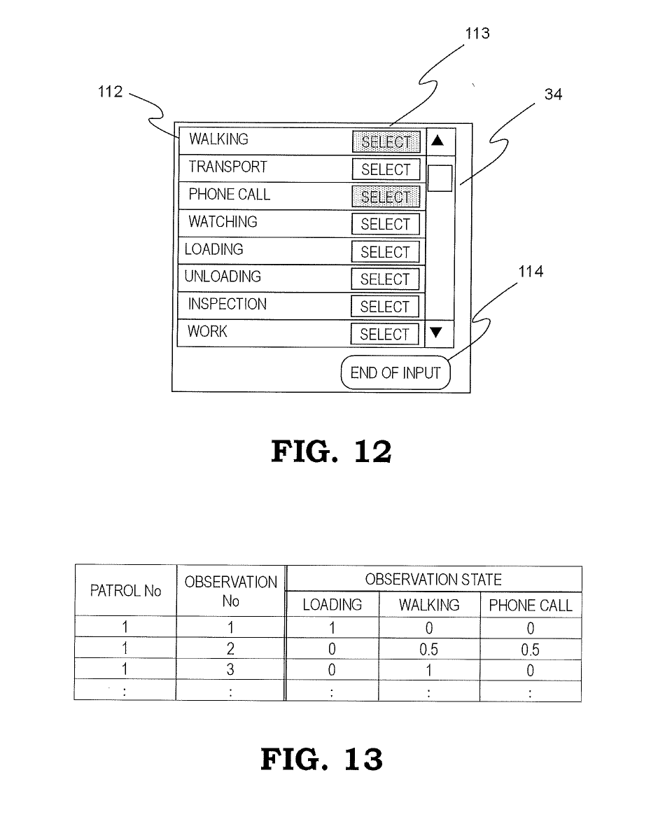

Next, FIG. 12 shows an example of the configuration of an input information display unit 34 of the observation state input unit 4 of the work state measurement device 1 according to EMBODIMENT 1. In the input information display unit 34, regarding the work state of a person to be observed, a work state item 112 which is classified by item is listed in advance and is displayed. In each work state item, a selection button 113 is attached, and a plurality of work state items can be selected. Regarding a button of an item which is selected, display style of the button is changed by changing color, etc. so as to show such that the button of the item is selected. In a case where one work state is observed, one selection button corresponding to the work state item is selected, and in a case where a plurality of work states are observed, a plurality of selection buttons corresponding to the work state items are selected. Further, in a case where the selected button is deselected, selection is deselected by pushing the same button again. In a case where the observation is finished, an input finishing button 114 is pressed. The work state item which is selected when observation is finished is recorded as the observation state, together with data which is weighted which will be described hereinafter, in the observation state record unit 5.

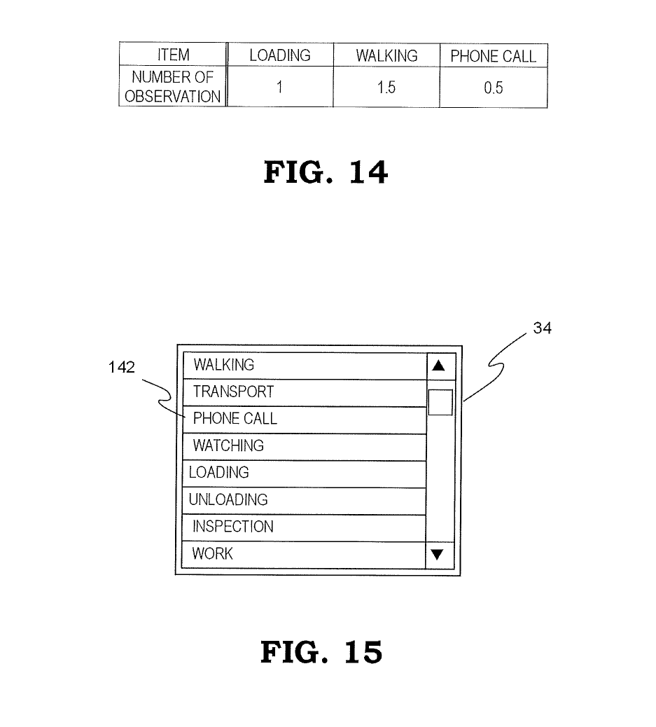

Next, FIG. 13 and FIG. 14 show the variety of data to be recorded in the observation state record unit 5 according to EMBODIMENT 1 of this invention. FIG. 13 shows data in which an observation state per patrol and per person to be observed (per observing No.) is recorded. In a case where the number of work state item which is inputted by the observation state input unit 4 is one, the item is recorded as one incident, and in a case where the number of work state time is two, each item is recorded as 0.5 incident. Hereinafter, in a case where the number of work state item is N pieces, a case is weighted as 1/N incident, and each of work state item is recorded as an observation state. That is, each of work state item is weighted equally by the inverse of the number of work state item which is inputted from observation starting timing to observation finishing timing, and then is recorded as an observation state in the observation state record unit 5. FIG. 14 shows the accumulation of the number of observation in which each item is weighted. The above-mentioned data is stored in a small-sized memory equipment such as an USB memory, a SD card, a built-in hard disk, etc.

According to EMBODIMENT 1 of this invention, a plurality of observation states from observation starting timing to observation finishing timing can be recorded, therefore, variation of results caused by observing by different observers can be reduced, as a result, the accuracy of observation result can be improved.

### Embodiment 2

FIG. 15 is a diagram for showing an example of the configuration of an input information display unit 34 of work state measurement device according to EMBODIMENT 2 of this invention. In an example of the configuration, a display part and an input part are configured by a touch panel, information which is displayed in the parts can be input by pressing with a finger or an input pen point. In the input information display unit 34, a work state item 142 of an object to be observed is listed and displayed, therefore by pressing a part corresponding to each work state, while the part has been pressed, it is indicated such that a work state has been continued. That is, in a case where the state is changed while being observed, pressing the work state item before the state is changed is finished, and pressing part is changed to the work state item after the state is changed. By doing the above-mentioned, the change of observation state while being observed can be shown by a pressing part of a touch panel and change amount of pressing time.

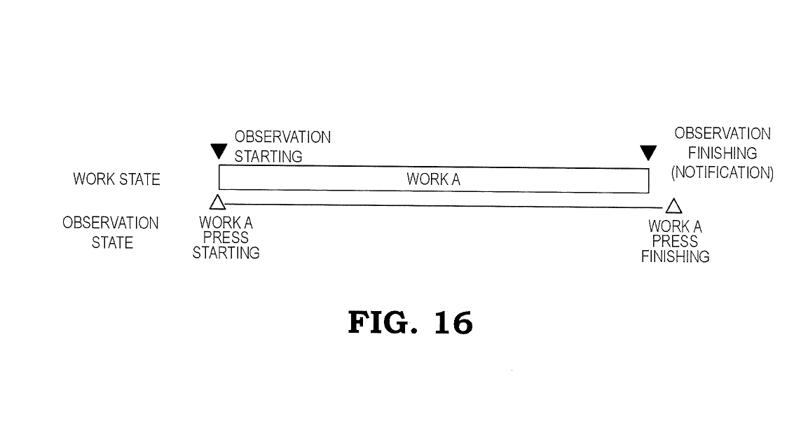

According to EMBODIMENT 1, regarding the number of case of observation which is inputted by an observation state input mechanism, corresponding to the number of work state item which is obtained by one observation, in a case of one incident, it is recorded as one incident, and in a case of two incidents, it is recorded as 0.5 incident. Hereinafter, in a case where N pieces of work state are observed, it is recorded as 1/N incident which is weighted equally. In an observation state input unit in EMBODIMENT 2, it is configured such that as an observation state, a work state item can be inputted by weighting with the ratio of observation time. Hereinafter, referring concretely to FIG. 16 to FIG. 20, a method to weight work state item corresponding to the ratio of observation time will be described.

FIG. 16 shows the state in which work A is continued during observation time. A point when an observer starts to input (starts to press) an work A of an object to be observed is observation starting. Then, the above-mentioned press state is continued until input is finished (press finishing) after observation finishing is noticed. In this case, the finishing time of the work A is replaced by notification time of observation finishing and is inputted so as for the length of the work A to be equal to the length of observation time. Further, in this case, the ratio of the work A which is occupied in the observation time is 100%, therefore the weight of the work A is 1.

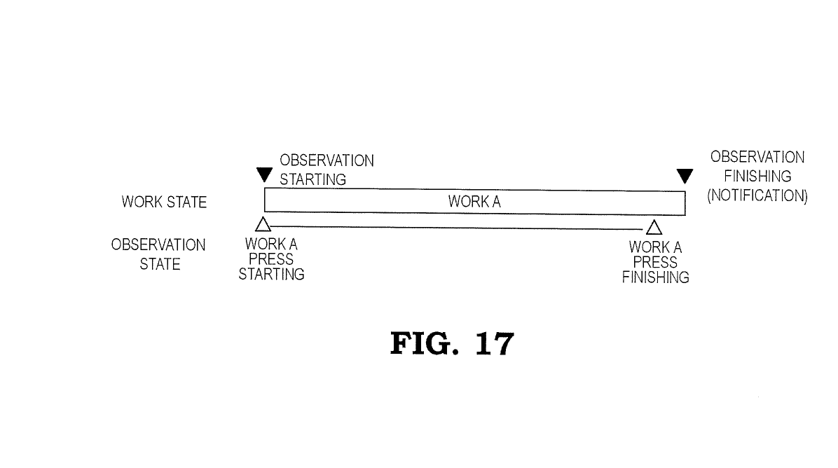

Next, in FIG. 17, the state in which the work A is continued during observation time is same as that in FIG. 16, however, an observer finishes inputting the work A of an object to be observed (pressing is finished) before the point when the observer receives the notification of observation finishing (in the manner of making premature start). Even in the above-mentioned case, the finishing time of the work A is replaced by notification time of observation finishing and is inputted so as for the length of the work A to be equal to the length of observation time. Further, in this case, the ratio of the work A which is occupied in the observation time is 100%, therefore the weight of the work A is 1.

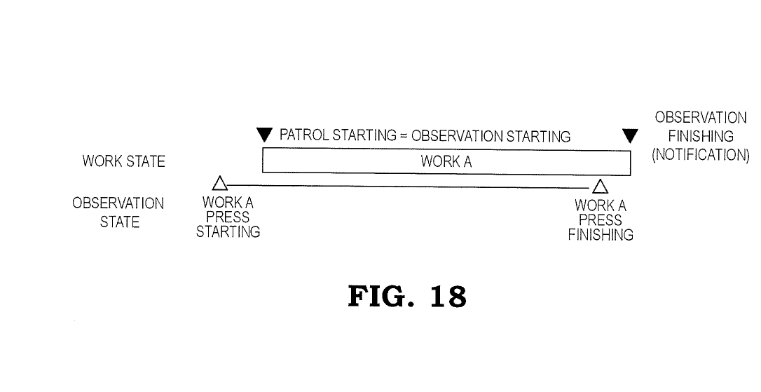

On the other hand, as shown in FIG. 18, in a case where the time when inputting the work A of an object to be observed is started (pressing is started) by an observer is before patrol starting time (premature start), the starting time of the work A is replaced by the patrol starting time (=observation starting time) and is inputted. Further, in this case, the ratio of the work A which is occupied in the observation time is 100%, therefore the weight of the work A is 1.

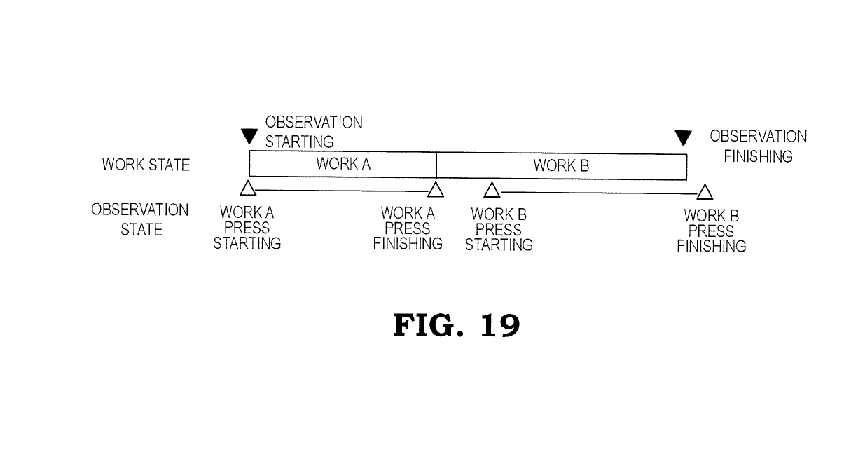

Next, FIG. 19 shows the state in which the work A is changed to the work B while being observed. The point, that is, a point when an observer starts to input (starts to press) an work A of an object to be observed is observation starting, is same. However, after that, it is observed such that the work state of an object to be observed is changed from the work A to the work B, and after that, an observer finishes inputting of the work A (press finishing), and then starts to input the work B (press starting). After the notification of observation finishing is received, the above-mentioned press state is continued until the inputting is finished. Also in this case, the starting time of the work B is replaced by the finishing time of the work A, the finishing time of the work B is replaced by the observation finishing time so as for the length of total time of the work A and the work B to be equal to the length of observation time. Further, in this case, the number of observation of the work A and the work B is ratio of observation which is occupied in the observation time, respectively. For example, in a case where the wok A is 1.2 seconds and the work B is 1.8 seconds, the weight of each of the work state of the work A is 0.4 and that of the work B is 0.6, respectively. That is, the work state item corresponding to the button which is pressed while the time starting from the observation starting timing to the observation finishing timing is weighted by the time while the button has being pressed and is recorded in an observation state record unit 5 as an observation state.

When the relationship between the starting time and finishing time of the above-mentioned each observation state is arranged, the starting time is later than the patrol starting time at the earliest, the starting time is (1) only in a case where the first observation state of a person to be observed, the pressing starting time of the observer, (2) in other cases, the finishing time (the time when the pressing is finished) of the observation state. Further, the finishing time is (1) only in a case where the last observation state of a person to be observed, the notification time of observation finishing, (2) in other cases, the finishing time of the observation state (the time when the pressing is finished).

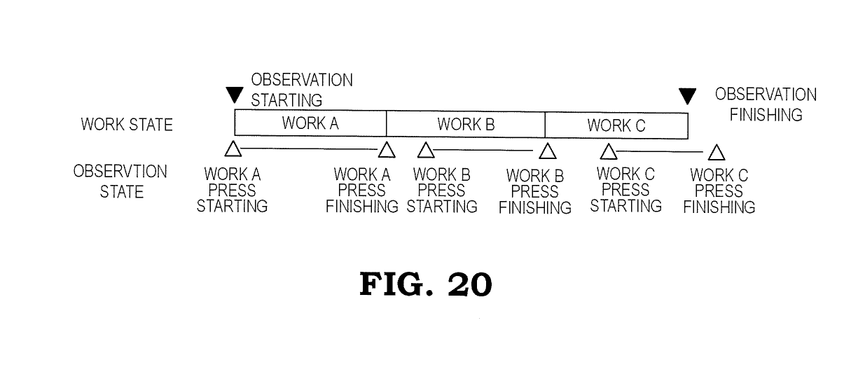

By defining as above-mentioned, as shown in FIG. 20, even in a case where the state is changed more than twice while being observed, that is, the state is changed from the work A to the work B, further to a work C, replacing in the same way can be performed.

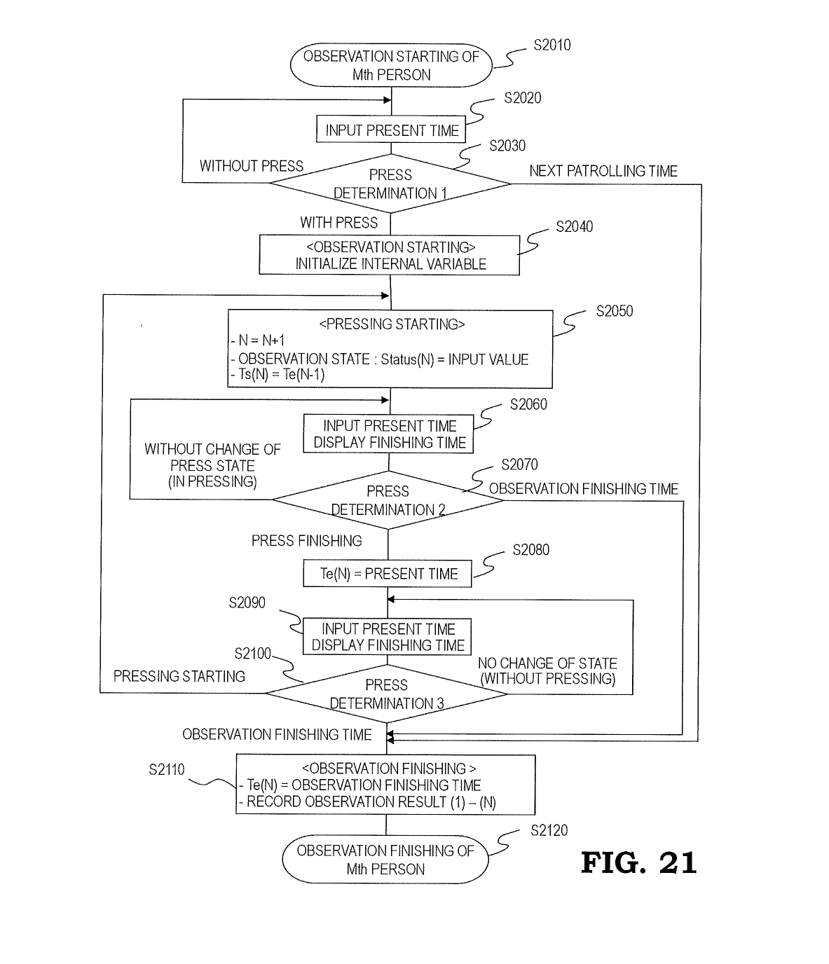

FIG. 21 is flow chart showing the operation of work state measurement device according to EMBODIMENT 2 of this invention. Via observation starting step (S2010), in step S2020, the preset time is inputted by a built-in clock, the following branch process is performed by determination step S2030. (1) When the present time gets to next patrol time (=“previous patrol”+“patrol interval” (both of them are obtained by patrol interval data), it is skipped to S2110, and observation is finished. (2) Until whether pressing is performed in the input information display unit 34 or not is determined and pressed, S2020 and S2030 are performed repeatedly so as to be waited. (3) When pressing is performed, in observation starting step 2040, the internal variable of program is initialized in observation starting step 2040. As initialization, (1) the present time (which is obtained by a built-in clock), (2) the number of observation of a person to be observed N is set to be 0, (3) observation starting time is set to be the present time, (4) observation finishing time is set to be observation starting time+observation time (which is obtained by observation time date), (5) in starting time Ts (N) and finishing time Te(N) of Nth observation state, Te(0) and Ts(1) is set to be the present time, respectively.

Next, in pressing starting step S2050, (1) N is set to be N+1, (2) Nth observation state: Status (N) is set to be the observation state input value, and (3) Ts(N) is set to be Te(N−1). Then, in step S2060, the present time is inputted by a built-in clock, and in determination step S2070, the following branch process is performed. (1) When the present time gets to observation finishing time, it is skipped to S2110 and observation is finished. (2) When change is not made while the input information display unit 34 has been pressed, S2060 and S2070 are performed repeatedly so as to be waited. (3) In a case where the pressed state is changed to the state in which pressing is not performed (pressing is finished), press finishing step 2080 is performed and finishing time Te(N) is set to be the present time.

After S2080 is performed, the work state item 142 in the input information display unit 34 is not pressed, then, again, inputting of the present time in S2090 and the following branch process in determination step S2100 is performed. (1) When the present time gets to the observation finishing time, observation is finished and S2110 is performed. (2) The work state item 142 in input information display unit 34 is not pressed and change is not made, S2090 and S2100 are performed repeatedly so as to be waited. (3) In a case where the state in which pressing is not formed is changed to the pressed state (pressing is started), steps after the press starting step 2050 will be repeated.

Finally, in observation finishing determination step S2110, (1) Te(N) is set to be observation finishing time, (2) information of each observation state form the first to the nth is recorded as an observation result, and the Mth observation is finished (S2120).

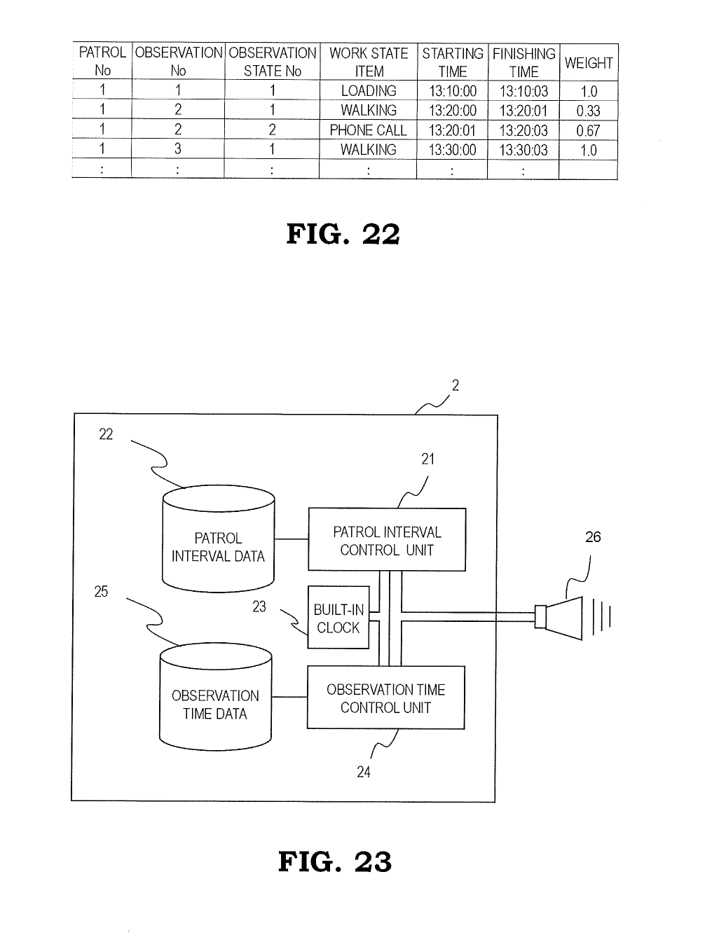

FIG. 22 is a diagram showing an example of observation result of work state measurement device according to EMBODIMENT 2 of this invention. In this example, in the order of observation state of each patrol, a work state item, starting time and finishing time, weight of each of work state item are recorded. According to EMBODIMENT 2 of this invention, when a plurality of observation states are recorded, each work state item which is observed is weighted corresponding to the time ratio, and division record is performed automatically as each observation state, therefore, labor which is required for analysis work can be reduced.

### Embodiment 3

FIG. 23 is a block diagram showing one example of the configuration of an observation timing notifying unit 2 of a work state measurement device according to EMBODIMENT 3 of this invention. In EMBODIMENT 1, in the observation timing notifying unit 2, an information display unit 3 is utilized as a means of notifying the patrol starting count-down as observation starting timing and observation finishing timing to an observer, however, in EMBODIMENT 3, as a means of notifying, sound from a speaker is utilized.

A patrol interval control unit 21 emits patrol starting count-down from a speaker 26. Further, an observation time control unit 24 emits sound from the speaker 26 at an observation starting point, and based on information which is stored in observation time data 25 and a built-in clock 23, at a point of observation finishing, emitting sound from the speaker 26 is stopped. As above mentioned, in an work state measurement device in EMBODIMENT 3, it is configured such that the observation timing notifying unit 2 emits notifying sound concerning observation from the speaker 26. Further, patrol interval data 22 and observation time data 25 is same as that in EMBODIMENT 1, therefore description regarding the above-mentioned will be omitted.

According to EMBODIMENT 3, patrol starting timing and observation finishing timing is informed by sound. Consequently, an observer can intensively perform observing an object to be observed without taking his/her eye off the object to be observed, as a result, accurate observing can be performed and quality of work analysis can be improved.

### Embodiment 4

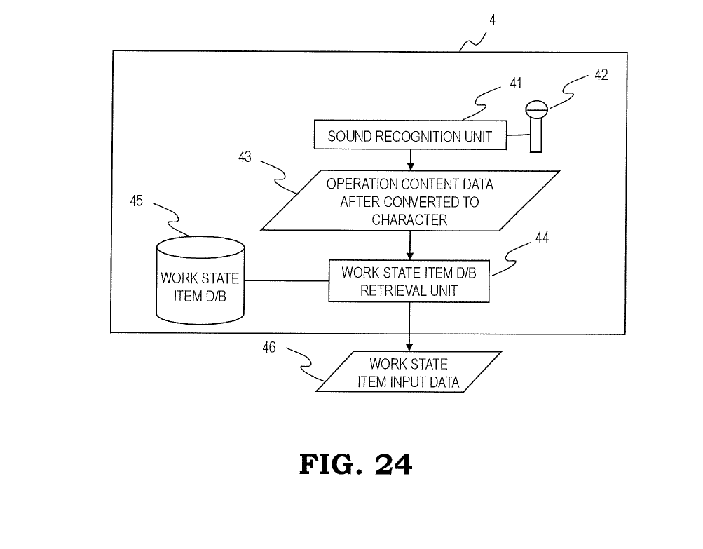

FIG. 24 is a block diagram showing one example of the configuration of an observation state input unit 4 of work state measurement device according to EMBODIMENT 4 of this invention. In EMBODIMENT 2, as an example of configuration of the observation state input unit 4, a touch panel is utilized, however, in EMBODIMENT 4, as an input means, a sound input is utilized.

A sound recognition unit 41 converts work content information which is indicated by a sound signal which is collected by a built-in microphone 42 as sound input equipment to characters and generates work content data after being converted to character 43. Next, a work state item D/B (data base) retrieval unit 44 checks the work content data after being converted to character 43 against a work state item D/B 45 and records a work state item corresponding to the work content data after being converted to character 43 as work state item input data 46 in an observation state record unit 5. Also in EMBODIMENT 4, in an observation state record unit, work state items, which are inputted as work state item input data by an observation state input unit 4 while from observation starting timing to observation finishing timing, are equally weighted by an inverse number of the number of the work state items which are inputted and are recorded as an observation state.

According to EMBODIMENT 4, in inputting an observation result, the observation result can be inputted by sound, therefore, necessary labor which is required for inputting operation can be reduced.

### Embodiment 5

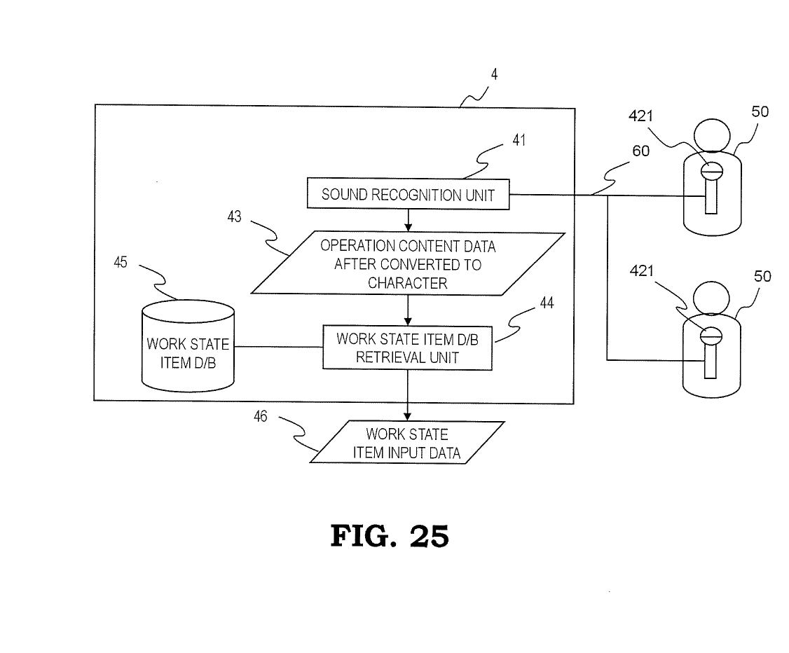

FIG. 25 is a block diagram showing one example of the configuration of an observation state input unit 4 of work state measurement device according to EMBODIMENT 5 of this invention. In EMBODIMENT 4, as an input means, a sound signal of an observer from a microphone is utilized, however, in EMBODIMENT 5, as an input means, a means, in which a person to be observed is made carry a microphone and input his/her own work content in the microphone is utilized.

By making a person to be observed 50 carry a microphone 421 as sound input equipment, his/her own work content is inputted by his/her sound signal. Information which is inputted is inputted to an observation state input unit 4 via a network 60. Regarding the network 60, similar form such as a cable LAN, a wireless LAN, etc. may be acceptable. In the same way as that of EMBODIMENT 4, information which is inputted is converted to characters and is recorded as work state item input data.

Further, in a case of a plurality of persons to be observed, a plurality of microphones 421 are connected. In this case, it is supposed such that persons to be observed may move to a place which is far from work state measurement device, therefore as a means of notifying observation timing, it is preferable such that sound is emitted by a speaker whose notification range is larger than that of a display function.

According to EMBODIMENT 5, inputting of observation result is performed by a person to be observed, therefore labor which is required for analyzing work of an observer can be reduced, and work content of a person to be observed is reported. As a result, observation accuracy of observation state is improved.

### Embodiment 6

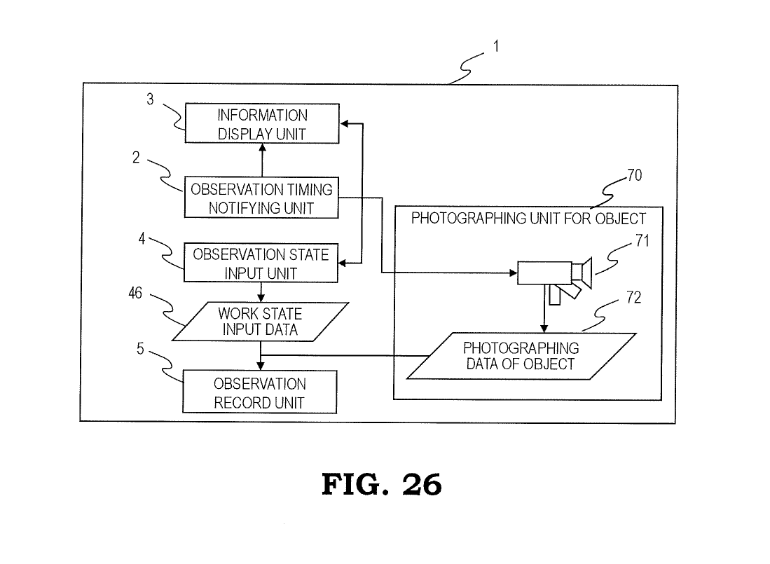

FIG. 26 is a block diagram showing the configuration of work state measurement device according to EMBODIMENT 6 of this invention and a photographing unit for an object to be observed 70 is provided. According to EMBODIMENTs 1 to 5, an observation state at a point of an observation time is recorded as character information, however, according to EMBODIMENT 6, there is a characteristic such that photographing information is also recorded at the same time.

The photographing unit for an object to be observed 70 has a built-in camera 71 which photographs a person to be observed in synchronization with an observation time which is notified by an observation timing notifying unit 2, and photographing result is retained as photographing data of an object to be observed 72. An observation state record unit 5 records the photographing data of an object to be observed 72 together with work state item input data 46 which is inputted by an observation state input unit and observation state data including weight data.

According to EMBODIMENT 6, by photographing an object to be observed at the same time of observing the object to be observed, an observation state can be checked after observation is finished, therefore an accuracy of observation is improved.

It is further understood by those skilled in the art that the foregoing description is a preferred embodiment of the disclosed device and that various changes and modification may be made in the invention without departing from the spirit and scope thereof.
1: work state measurement device
2: observation timing notifying unit
3: information display unit
4: observation state input unit
5: observation state record unit
26: speaker
41: sound recognition unit
42, 421: microphone (sound input equipment)
70: photographing unit for an object to be observed
72: photographing date of an object to be observed

1. A work state measurement device, which records a result of observing a work state of a worker which is an object to be observed as an observation state, comprising;
an observation timing notifying unit which notifies observation starting timing and observation finishing timing as observation timing to an observer in every preliminarily set time interval,
an observation state input unit which divides the work state which is observed into a plurality of work state items and inputs the work state items, and
an observation state record unit which weights the work state items, which are inputted while from the observation starting timing to the observation finishing timing, by information of the work state items which are inputted, and records the work state items as observation states.

2. The work state measurement device as in claim 1,
wherein the observation state record unit weights the inputted work state items equally by the inverse of the number of the work state items which are inputted from the observation starting timing to the observation finishing timing, and then records the inputted work state items as the observation states.

3. The work state measurement device as in claim 2,
wherein the observation state input unit comprises a touch panel in which the plurality of work state items are displayed by a plurality of buttons per a work state item, and the observation state record unit weights the work state item corresponding to the button which is pressed and records the work state item as the observation state.

4. The work state measurement device as in claim 1,
wherein the observation state input unit comprises a touch panel in which the plurality of work state items are displayed by a plurality of buttons, the observation state record unit weights the work state item corresponding to a button which is pressed in the observation state input unit while from the observation starting timing to the observation finishing timing by a length of time while the button has been pressed and records the work state item as the observation state.

5. The work state measurement device as in claim 1,
wherein the observation timing notifying unit emits notifying sound concerning the observation from a speaker.

6. The work state measurement device as in claim 1,
wherein the observation state input unit comprises a sound recognition unit which converts a sound signal to characters and inputs the work state item by a sound signal from sound input equipment.

7. The work state measurement device as in claim 6,
wherein the observation state input unit inputs the work state item by an observer's sound signal which is generated by sound input equipment.

8. The work state measurement device as in claim 6, wherein the observation state input unit inputs the work state item by a sound signal from sound input equipment which is carried by the worker.

9. The work state measurement device as in claim 1,
further comprising a photographing unit for an object to be observed, wherein the photographing unit for an object to be observed photographs the object to be observed while from the observation starting timing to the observation finishing timing and records the photographed data as photograph data of an object to be observed in the observation state record unit.

10. A work state measurement method, which records an observation result of observing a work state of a worker which is an object to be observed by a calculator, comprising
an observation timing notifying step which notifies observation starting timing and observation finishing timing as observation timing to an observer in every preliminarily set time interval,
an observation state input step which divides an observed work state into a plurality of work state items and inputs the work state items and
an observation state record step which weights work state items which are inputted while from observation starting timing to observation finishing timing and records the work state item as observation states.

11. The work state measurement method as in claim 10,
wherein the observation state record step weights the work state items equally by the inverse of the number of the work state items which are inputted while from the observation starting timing to the observation finishing timing, and then records the inputted work state items as the observation states.

12. The work state measurement method as in claim 10,
wherein the observation state input step comprises
a step which shows a button per the work state item in a touch panel, in the observation state record step, the work state item corresponding to the button which is pressed while from the observation starting timing to the observation finishing timing is weighted by a length of time while the button has been pressed and is recorded as the observation state.

13.-15. (canceled)
